(19) United States
(12) Patent Application Publication
(10) Pub. No.: US 2012/0326896 A1
(43) Pub. Date: Dec. 27, 2012

(54) PROVIDING LOCATION-BASED TRAFFIC INFORMATION SERVICE

(75) Inventors: Ying Chen, Beijing (CN); Rong Yao Fu, Beijing (CN); Qian Ma, Beijing (CN); Hao Wang, Beijing (CN); Yue Da Xiong, Beijing (CN); Yuan Yuan, Beijing (CN)

(73) Assignee: International Business Machines Corporation, Armonk, NY (US)

(21) Appl. No.: 13/603,593

(22) Filed: Sep. 5, 2012

Related U.S. Application Data
(63) Continuation of application No. 13/479,309, filed on May 24, 2012.

(30) Foreign Application Priority Data
May 27, 2011 (CN) 201110146377.4

(51) Int. Cl. G08G 1/123

(52) U.S. Cl. 340/989

(57) ABSTRACT

A method, apparatus, and service station for providing a location-based transportation information service. The method for providing a location-based traffic information service includes receiving a traffic message indicating a traffic condition, determining a traffic information service station matching the traffic message in terms of location, and dispatching the traffic message to the matched traffic information service station such that the traffic message is broadcasted within the service range of the matched traffic information service station. Corresponding apparatus and traffic information service station are also disclosed. According to embodiments of the present invention, a location-specific real-time traffic information service can be provided.

### CROSS-REFERENCE TO RELATED APPLICATION

This application is a continuation of and claims priority from U.S. patent application Ser. No. 13/479,309, filed May 24, 2012, which in turn claims priority under 35 U.S.C. §119 from Chinese Patent Application No. 201110146377.4 filed May 27, 2011, the entire contents of both are incorporated herein by reference.

### BACKGROUND OF THE INVENTION

1. Field of the Invention

Embodiments of the present invention generally relates to a location-based service, and more specifically, relates to a method, apparatus, and service station for providing location-based traffic information service.

2. Description of Related Art

With the development of modern society, the automobile traffic is closely related to society development and people's daily life. How to provide traffic information services for travelling users such as drivers, pedestrians, and passengers is an issue worthy of attention. Unfortunately, there is no effective means for providing accurate traffic service information for users even though traffic monitoring, management measures, and facilities are gradually improving.

Traditionally, the traffic information service is based on an information collection processing pattern. Particularly, the traffic information is generally collected collectively by the traffic management department and then collectively released by means of TV station, broadcast radio station, and mobile communication technologies (for example, short messaging service SMS and/or multimedia messaging service MMS). In such patterns, the traffic information service is globally oriented, not specific to each user. In other words, since the information contained in these services is independent of the current location and status of a user, it can be not valuable to the user.

A driver usually only focuses on the traffic information where he/she is currently located, not paying attention to traffic information of any other areas. Currently, the traffic management department still lacks effective means for transmitting the traffic evacuation information. For example, when traffic jams or traffic accidents occur in an area, the traffic management department has to wait for arrival of emergency personnel, such as police, to perform field evacuation. The waiting period creates more severe traffic congestion.

In order to solve the technical problem of providing a pertinent traffic information service for users, traffic information services by means of location-based service (LBS) technology have been proposed. The existing location-based traffic information service solution can be generally divided into two classes. The first class of solutions allows a user to mount on his/her automobile a positioning device. The positioning device can be a global positioning system (GPS) receiver and an information transmitting device. In this way, the user can obtain a current location while driving and transmit the current location to a relevant server. The server can then provide pertinent traffic information service for the user based on his/her current location.

The second class of solutions requires the user to mount a positioning device and an information filtering device at the transportation vehicle. According to this class, the server still pushes the global transportation service information to the user's receiver, as in the traditional manner. Before broadcasting such information to the user, the information is filtered by the information filtering device equipped on the transportation vehicle based on the user's current location as obtained by the positioning device. Therefore, only the current location-related transportation service information is retained.

Although the above location-based traffic information services alleviate the problem existing in the traditional transportation service to a certain extent, they suffer from their own drawbacks. For example, in the above location-based traffic information services, additional devices are required to be mounted on the user's automobile, and to the transportation vehicle itself (for example, the vehicle's circuitry, physical structure, etc.) even needs to be modified. This will result in extra cost and can cause potential dangers to the user.

Thus, a need exists in the art for providing users with a more effective solution of a location-based traffic information service. Therefore, embodiments of the present invention provide a method, apparatus, and service station for providing a location-based traffic information service.

### SUMMARY OF THE INVENTION

According to one aspect of the present invention, a method for providing a location-based traffic information service is provided. The method includes receiving a traffic message indicating a traffic condition, determining a traffic information service station matching the traffic information in terms of location, and dispatching the traffic message to the matched traffic information service station, so that the traffic message is broadcasted within the service range of the matched traffic information service station.

According to another aspect of the present invention, an apparatus for providing a location-based traffic information service is provided. The apparatus includes receiving means configured to receive a traffic message indicating a traffic condition, determining means configured to determine a traffic information service station matching the traffic information in terms of location, and dispatching means configured to dispatch the traffic message to the matched traffic information service station, so that the traffic message is broadcasted within a service range of the matched traffic information service station.

According to a further aspect of the present invention, a traffic information service station is provided. The traffic information service station includes message receiving means configured to receive a traffic message from a server, the server including an apparatus for providing a location-based traffic information service as described above, and message broadcasting means configured to broadcast the traffic message within a service range of the traffic information service station.

### BRIEF DESCRIPTION OF THE DRAWINGS

Through reading the following detailed description with reference to the accompanying drawings, the above and other objectives, features and advantages of embodiments of the present invention will become more comprehensible. In the drawings, a plurality of embodiments of the present invention will be illustrated in an exemplary and non-limiting manner, wherein:

FIG. 1 illustrates a flow chart of a method 100 of providing a location-based traffic information service according to an embodiment of the present invention;

FIG. 2 illustrates a flow chart of a method 200 of providing a location-based traffic information service according to another embodiment of the present invention;

FIG. 3 illustrates a block diagram of an apparatus 300 for providing a location-based traffic information service according to an embodiment of the present invention;

FIG. 4 illustrates a block diagram of an apparatus 400 for providing a location-based traffic information service according to another embodiment of the present invention;

FIG. 5 illustrates a block diagram of a traffic information service station 500 according to an embodiment of the present invention;

FIG. 6 illustrates a block diagram of a traffic information service station 600 according to another embodiment of the present invention;

FIG. 7 illustrates a block diagram of a system 700 of providing a location-based traffic information service according to an embodiment of the present invention;

FIG. 8 illustrates a block diagram of an exemplary computer system 800 that is adapted to be used with an embodiment of the present invention.

### DETAILED DESCRIPTION OF THE PREFERRED EMBODIMENTS

It can be appreciated through the following detailed depiction that according to embodiments of the present invention, traffic information service stations can be deployed at a plurality of locations, and preferably, each traffic information service station can be equipped with a radio broadcast transmitting device. The server can receive traffic messages that indicate traffic conditions, and classify these messages based on the specific location relating to each piece of traffic message and the location of each traffic information service station. Then, the classified traffic messages are dispatched to related or matched traffic information service stations according to locations.

The traffic information server can then broadcast the received traffic messages within a particular service range. In this way, as long as the user tunes the radio receiver (for example, a vehicle radio station terminal) on his/her transportation vehicle to a corresponding frequency, with he/she passing through service ranges of different traffic information service stations, the traffic information services relating to the user's current particular location and broadcast from the corresponding traffic information service station can be obtained in real-time during the travelling.

Therefore, in embodiments of the present invention, the traditional information collection processing pattern is replaced with an information classification processing pattern. Such transformation of information processing pattern enables the traditional collective traffic information service to be converted into a distributive, location-based individualized traffic information service. Further, comparing to the prior solution of location-based service, embodiments of the present invention requires no reconstruction of the user's transportation vehicle, thereby reducing cost and enhancing safety.

Hereinafter, embodiments of the present invention will be described in detail with reference to the drawings. As the above mentioned in brief and the following discussed in detail, in an embodiment of the present invention, an personalized location-based traffic information service can be implemented by classifying the received traffic messages that indicate traffic conditions and by dispatching each traffic message to a traffic information service station at the corresponding location, so as to broadcast within a particular range.

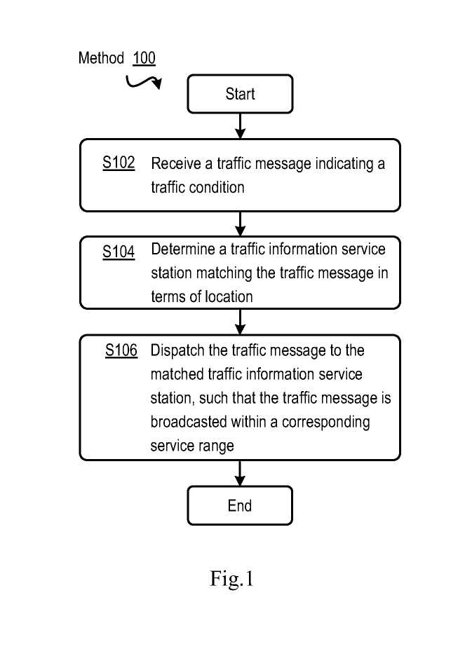

Reference is first made to FIG. 1, where a flow chart of a method 100 of providing a location-based traffic information service according to an embodiment of the present invention is illustrated. It should be noted that, each step as specified in the method 100 can be implemented in different orders and/or in parallel. The method 100 can further include an additional step and/or omit an illustrated step. The scope of the present invention is not limited in this regard.

After the method 100 starts, at step S102, a traffic message indicating a traffic condition is received. The term “traffic condition” means any condition related to transportation, for example, including, but not limited to one or more of the following: relevant location, road congestion condition, average traveling speed of vehicles, temporary traffic regulation measure, traffic accident information, events that happen in the surrounding areas and can impact the traffic, etc.

The traffic message can be generated through various technical means, whether currently known or developed in the future. For example, the traffic message can be manually generated by personnel responsible for monitoring the traffic condition. Alternatively or additionally, the traffic message can be generated by processing and handling the information obtained by devices such as a camera, a video camera, or a velocimeter. Other generation manners of a traffic message are also possible, and the scope of the present invention is not limited hereto.

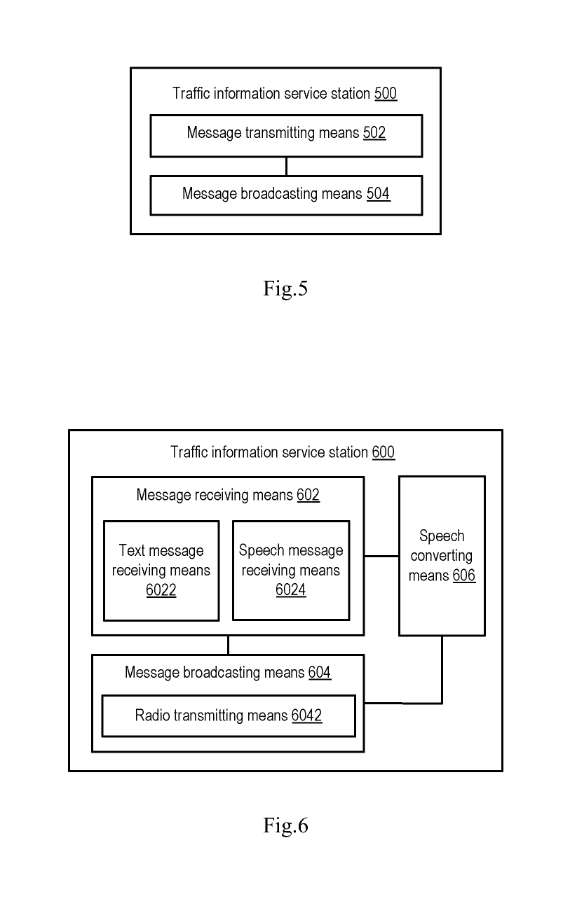

According to embodiments of the present invention, after the traffic message is generated, it can be obtained by a device called “message collector” and transferred by the device to a server. Correspondingly, at step S102, the message regarding traffic condition is received by the server from the message collector. The message collector and the server will be described in detail with reference to FIG. 5.

According to some embodiments of the present invention, the traffic message received at step S102 can be a text message. This text message can be of various kinds of formats and structures. For example, such a text message can be a planar text without a structure that includes direct literal depiction on the traffic condition. Alternatively, the text message regarding traffic condition can also be a structured message, namely, the message including one or more fields for recording information. For example, based on some exemplary embodiments, the structured text message can include, for example, one or more of the following fields:
Location, indicating the area, road or site where a traffic accident or problem occurs;
Event depiction, indicating the traffic problem or weather condition (for example, congestion incurred by the accident) and possibly indicating the seriousness of the problem (for example, the resulting length of the vehicle queue);
Direction and range, determining the adjacent road or the location of the particular site that is affected by the event, and possibly indicating the direction of the traffic;
Duration, indicating the expected duration of the problem; and
Traffic evacuation suggestion, indicating whether to suggest that the driver making a response or complying with a given alternative route.

In some embodiments of the present invention, the information included in the above field can be textual depiction or a corresponding predetermined encoding. As an example, Table 1 below provides an example of a structured text message. In the example of Table 1, the structured message can be implemented for example through an extensible markup language (XML), where each field stores a predetermined encoding corresponding to respective information. For example, the location code “24” can correspond to the address “fly-over bridge A,” and the event description “189” can represent “rear-end collision accident occurs in the middle lane,” etc.

TABLE 1
Exemplary Textual Message Regarding Traffic Condition

| Serial | Locat- | Event | Direc- | | Dura- | Evacuation |
|---|---|---|---|---|---|---|
| Number | ion | Description | tion | Range | tion | Suggestion |
| 1 | 24 | 189 | 0 | 0 | 1 | 0 |
| 2 | 329 | 191 | 1 | 0 | 2 | 0 |
| 3 | 179 | 190 | 1 | 0 | 4 | 1 |
| 4 | 181 | 193 | 0 | 0 | 3 | 1 |

It should be understood that the above description and the illustration in Table 1 are only for exemplary purposes rather than limiting the present invention in any manner. Actually, in addition to the above description or alternatively, the textual message regarding traffic condition can have various kinds of formats and fields, and the scope of the present invention is not limited in this regard.

According to some further embodiments of the present invention, the traffic message received at step S102 can be a speech message. The speech message can be direction description regarding traffic condition. For example, “road B travels smoothly.” This kind of speech messages, for example, can be generated manually by personnel responsible for traffic monitoring (for example, by transcription). Alternatively or additionally, the speech message can, for example, be generated by applying speech conversion (for example text-to-speech TTS conversion technology) to the textual message. Other generation manners of a traffic message are also possible, and the scope of the present invention is not limited hereto.

Next, the method 100 proceeds to step S104, where it is determined a traffic information service station matching the traffic message as received at step S102 in terms of location.

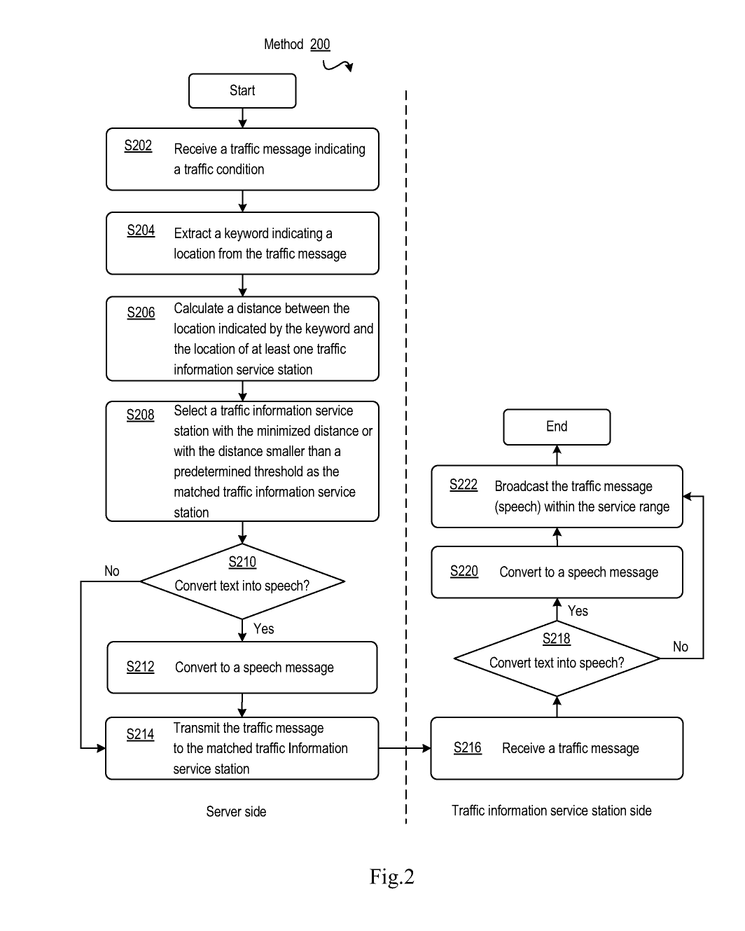

The term “traffic information service station” used here refers to any suitable entity that can receive the traffic messages and broadcast these messages within a particular range and that have an information processing capability. According to embodiments of the present invention, one or more traffic information service stations can be deployed at any suitable location. It can be understood that the location information of each traffic message service station is available. For example, such information can be determined and saved when deploying the traffic information service station. Besides, at step S104, the location that is associated with the traffic message as received at step S102 is also determined. The specific determining manner will be described in detail with reference to FIG. 2.

Given the association location of the traffic message and the location of the traffic information service station, it is possible to determine the traffic information service station matching the current message in terms of location in various manners. For example, according to preferred embodiments of the present invention, the matched traffic information service station can be determined based on the distance between the associated location of the traffic message and each traffic information service station (which will be described in detail with reference to FIG. 2).

In addition to quantitatively calculating the distance or alternatively, a matched traffic information service station can be determined based on a predetermined mapping table between the associated location of the traffic message and the traffic information service station. For example, this class of mapping tables can prescribe that locations A and B should be mapped to traffic information service station 1, while locations C, D should be mapped to traffic information service station 2. In this case, if the traffic message is associated with location A, then it can be determined based on the mapping table that the traffic information service station 1 is the traffic information service station matching the traffic message. As another possible embodiment, a traffic information service station matching the traffic message can be determined manually. Other manners are possible, and the scope of the present invention is not limited in this regard.

Particularly, at step S104, the traffic information service station matching the traffic message as determined at step S104 can be more than one, which will be described in detail.

Next, the method 100 proceeds to step S106, where the traffic message is dispatched to the matched traffic information service station, such that the traffic message is broadcasted within the service range of the matched traffic information service station.

The traffic message can be transmitted to the traffic information service station through any cabled and/or wireless communication channel that is currently known. According to embodiments of the present invention, each traffic service information service station has an associated service range. After receiving the traffic message, the matched traffic information service station can broadcast this traffic message within the service range.

It should be noted that according to embodiments of the present invention, for any traffic information service station, it only broadcasts the received traffic message within its service range. Through suitably setting the location and service range of each traffic information service station, it can be guaranteed that the message broadcast by each traffic information service station is always directed to a particular geographic location.

For example, according to embodiments of the present invention, traffic information service stations can be set at important crossroads or areas, and each traffic information service station only serves the crossroad or area where it is located as its service range. In other words, the service range will only cover the crossroad or area where it is located. When the user is at a crossroad or area, the information received by him/her from the corresponding traffic information service station is always specific to that crossroad or area. Thus, it is possible to avoid broadcasting to the user traffic conditions of irrelevant areas, thereby effectively implementing the location-based personalized traffic information service.

According to embodiments of the present invention, the traffic information service station can broadcast traffic messages within its service range in various manners, for example, including but not limited to one or more of the following: textual message, multimedia message, audio, video, etc. Preferably, the traffic information service station can be equipped with a radio transmitting device, for example, an FM or AM radio transmission device, so as to broadcast the traffic message using radio communication. It can be understood that in this embodiment, the service range of a traffic information service station can be controlled through setting the parameters of the radio transmitting device such as transmission power, antenna direction, etc.

It can be understood that in an embodiment of employing a radio communication, the textual message generally needs to be converted into a speech message before broadcasting. The conversion of textual message to speech message can be implemented at the server side, and then the resulting speech message is transmitted to the traffic information service station. Alternatively, the conversion of textual message to speech message can also be implemented at the traffic information service station. This will be described in detail with reference to FIG. 2.

The radio frequencies used by a plurality of traffic information service stations can be identical or different. When deploying a plurality of traffic information service stations, the service ranges of any two traffic information service stations can be arranged not to be overlapped, or to be overlapped as least as possible. Meanwhile, the service ranges of these traffic information service stations are arranged to form coverage areas as continuous as possible. At this point, each traffic information service station can preferably use the same radio frequencies. In this way, as long as the user tunes the radio receiver on his/her transportation vehicle to the frequency, the user can continuously receive the traffic information service specific to the current location without tuning the receiver when he/she travels across the service ranges of a plurality of traffic information service stations.

In some further scenarios, the service ranges of two traffic information service stations can have relatively large overlapping areas. In order to avoid potential conflict within the overlapped area, the two traffic information service station can use different radio frequencies. Depending on user experience, it is not essential (for example, if it is determined that the user can accept a temporary interference of the overlapping range, the two can use a same radio frequency).

Through the above depiction on the method 100 with reference to FIG. 1, those skilled in the art can understand, according to embodiments of the present invention, by classifying and dispatching the traffic messages that are received at the server, respective traffic information service stations only broadcast the traffic message relating to their own geographical locations within the particular ranges. In this way, location-based real-time traffic information service can be implemented without mounting any device at the user's transportation vehicle.

Now referring to FIG. 2, a flow chart of a method 200 of providing a location-based traffic information service according to another embodiment of the present invention is illustrated. It should be noted that steps S202 to S204 in the method 200 can be implemented at the server side as a preferred and differentiated embodiment of the method 100 as above described with reference to FIG. 1 (more specifically, implemented by an apparatuses 300 or 400), while steps S216 and S222 can be implemented at the traffic information service station side. Moreover, particularly, the traffic information service station in the method 200 uses a radio communication to broadcast the traffic message.

After the method 200 starts, at step S202, a traffic message indicating a traffic condition is received. Step S202 corresponds to step S101 in the method 100 and is thus not detailed here. Next, the method 200 proceeds to step S204, where a keyword indicating a location is extracted from the traffic message. As previously mentioned, according to embodiments of the present invention, the traffic message can be an unstructured text message. In this case, a keyword indicating a location (for example, “street A,” “crossroad B,” “fly-over bridge C,” etc.) can be extracted from the text of the message using any text processing technology (for example, character string processing, word segmentation, word match, synonym replacement, etc.) that is currently known or developed in the future. As a simple and feasible example, a repository that stores predetermined location keywords can be maintained. For a given textual traffic message, determination is made as to whether it contains a location keyword or synonym as stored in the repository by use of various character string segmentation and matching algorithms.

In some other scenarios, the traffic message can be a structured textual message. At this point, a keyword indicating a location can be extracted by reading corresponding fields. It can be understood that if a field stores a corresponding code of a location in a field, the extracting at step S204 can further include a necessary conversion or mapping process.

Besides, the traffic message that is received at step S202 can be a speech message, as above mentioned. In this case, the speech can be converted into a text through any speech recognition technology that is currently known or developed in the future, and then the keyword indicating the location is extracted using a text processing technology.

Next, the method 200 proceeds to step S206, where the distance between the location indicated by the keyword and the location of at least one traffic information service station as already deployed is calculated. It can be appreciated that for the keyword as obtained at step S204, specific coordinate (for example longitude-latitude coordinates) of the location as indicated by the keyword can be determined. For example, the coordinate information of the location can be stored in the above mentioned repository. Only as an example, the entries in this kind of repository are illustrated for example in Table 2 below.

TABLE 2
Exemplary Repository Entries Storing Location Information

| Number | Location Keyword | Location Coordinate |
|---|---|---|
| 1 | Location A | (longitude value, altitude value) |
| 2 | Location B | (longitude value, altitude value) |
| 3 | Location C | (longitude value, altitude value) |

As previously mentioned, the location information of the traffic information service station is available as well. Thus, a distance between the location as indicated by the keyword and each traffic information service station can be calculated (for example, the Euclidean Distance).

The method 200 further proceeds to step S208. Based on the distance as calculated at step S206, a traffic information service station that minimizes the distance can be selected as the traffic information service station matching the current traffic message. In other words, a traffic information service station matching a given traffic message is the traffic information service station that is closest to the location relating to the traffic message. It can be appreciated that when two or more traffic information service stations have an equal distance to the location relating to the traffic message, they can be simultaneously determined as matched traffic information service stations. Alternatively, a unique matched traffic information service station can be selected therefrom through any suitable tie-breaker rule or manually.

As another exemplary alternative embodiment of step S208, one or more traffic information service stations with a distance to the location indicated by the keyword smaller than a predetermined threshold as the traffic information service station(s) matching the traffic message. According to embodiments of the present invention, the predetermined threshold can be manually and/or automatically configured.

Afterwards, at step S210, it is determined whether to perform converting a text into a speech. If “yes,” then at step S212, the text message is converted into a speech message. Any TTS technology that is currently known or developed in the future is suitable for embodiments of the present invention, and the scope of the present invention is not limited in this regard. Particularly, the conversion is performed at the server side before the message is transmitted. The method 200 proceeds to step S214 after step S212. If the result of determining at step S210 is No (for example, if it is determined that the speech conversion is not implemented at the server side, or the received traffic message itself has already been a speech message and thus needs no conversion), then the method 200 proceeds to step S214.

At step S214, the serve transmits the traffic message to the matched traffic information service station. The traffic message as transmitted here can be a text message or a speech message. At step S214, the message can be transmitted using any cabled and/or wireless communication technology that is currently known and the scope of the present invention is not limited in this regard.

Then, at step S216, the matched traffic information service station receives the traffic message from the server. Next, at step S218, the traffic information service station determines whether it is necessary to convert the text message into a speech message. If “yes,” then at step S220, the text message is converted into a speech message. Step S220 is similar to step S212, with the difference lying in that the conversion is performed at the traffic information service station rather than at the server. The method 200 proceeds to step S222 after step S220. On the other hand, if what is transmitted from the server to the traffic information service station at step S214 is a resulting speech message, then the result of determining at step s218 is “No,” and the method 200 proceeds to step S222.

At step S222, the traffic information service station broadcasts the traffic message within its service range. In particular, each traffic information service station uses a particular radio frequency to broadcast the traffic message in the speech form. By suitably setting the parameters of the radio transmitting means of the traffic information service station, such as the transmission power and antenna direction, it can be guaranteed that the traffic message is only broadcast within the service range of a matched traffic information service station.

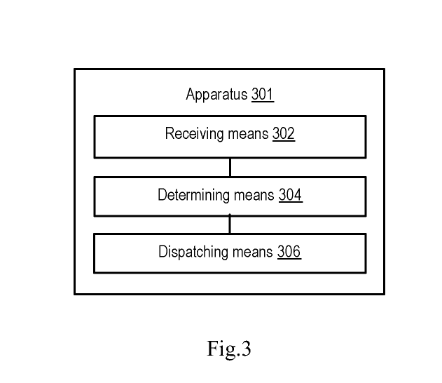

Now referring to FIG. 3, a block diagram of an apparatus 300 for providing a location-based traffic information service according to an embodiment of the present invention is illustrated. As shown, according to an embodiment of the present invention, the apparatus 300 includes receiving means 302 configurable to receive a traffic message indicating a traffic condition, determining means 304 configurable to determine a traffic information service station matching the traffic message in terms of location, and dispatching means 306 configurable to dispatch the traffic message to the matched traffic information service station, such that the traffic message is broadcasted within a service range of the matched traffic information service station.

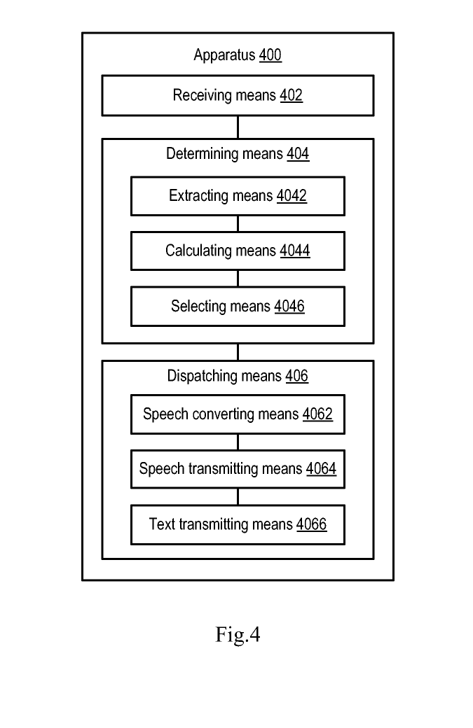

Now referring to FIG. 4, a block diagram of an apparatus 400 for providing a location-based traffic information service according to another embodiment of the present invention is illustrated. As shown, the apparatus 400 includes receiving means 402, determining means 404, and dispatching means 406, which correspond to the receiving means 302, determining means 304, and dispatching means 306 as illustrated in FIG. 3, respectively. In particular, in the embodiment as illustrated in FIG. 4, the determining means 404 can further include extracting means 4042 configurable to extract a keyword indicating a location from the traffic message, calculating means 4044 configurable to calculate a distance between the location indicated by the keyword and a location of at least one traffic information service station, and selecting means 4046 configurable to select a traffic information service station that has a minimal distance or a distance smaller than the predetermined threshold as the traffic information service station matching the traffic message.

Besides, in the apparatus 400 as illustrated in FIG. 4, the dispatching means 406 can further include speech converting means 4062 configurable to convert a text message into a speech message, speech transmitting means 4064 configurable to transmit a speech message to the matched traffic information service station. Besides, the dispatching means 4046 can further include text transmitting means 4046 configurable to transmit a text message to the matched traffic information service station.

It can be appreciated that the apparatus 300 and apparatus 400 can act as the subjects that perform the method 100 and steps S202-S214 in the method 200. Thus, the means and sub-means as included in the apparatus 300 and apparatus 400 correspond to respective steps of the method 100 and method 200, respectively. Thus, all of the above features and operations as described for the method 100 and method 200 are likewise applicable to the apparatus 300 and apparatus 400, which will not be detailed here.

Now referring to FIG. 5, a block diagram of a traffic information service station 500 according to an embodiment of the present invention is illustrated. As shown, the traffic information service station 500 includes message receiving means configurable to receive a traffic message from a server, the server including a device that provides a location-based traffic information service, for example, the apparatus 300 as above described with reference to FIG. 3 and the apparatus 400 as described with reference to FIG. 4. Besides, according to embodiments of the present invention, the traffic information service station 500 further includes message broadcasting means that is configured to broadcast a traffic message within an associated service range. According to embodiments of the present invention, the service range of the traffic information service station 500 can overlap or not overlap with the service range of another traffic information service station.

Now, referring to FIG. 6, a block diagram of a traffic information service station 600 according to another embodiment of the present invention is illustrated. As shown in FIG. 6, the traffic information service station 600 includes message receiving means 602 and message broadcasting means 604, corresponding to the message receiving means 502 and message broadcasting means 504 in FIG. 5, respectively. In particular, in the embodiment of FIG. 6, the message receiving means 602 can further include speech message receiving means 6022 configurable to receive a speech message from the receiver. Alternatively or additionally, the message receiving means 602 can further include text message receiving means 6024 configurable to receive a text message from the server. In this embodiment, the traffic information service station 600 can further include speech conversion means 606 configurable to convert the received text message into a speech message.

Besides, in the embodiment of FIG. 6, the message broadcasting means 604 can further include: radio transmitting means 6042 that is configured to use radio communication to broadcast the traffic message. According to some embodiments, the radio transmitting means 6042 and radio transmitting means of another traffic information service station use the same or different radio frequencies.

Moreover, similar to the traffic information service station 500 in FIG. 5, the service range of the traffic information service station as illustrated in FIG. 6 can or cannot overlap with the service range of another traffic information service station.

It should be understood that the traffic information service stations 500 and 600 as described in FIGS. 5 and 6 can service as the entities that perform steps S216 to S222 in the method 200. Therefore, all the features and operations as described for steps S216 to S222 in the method 200 are likewise applicable to the traffic information service stations 500 and 600, which will not be detailed here.

It should be understood that respective means in the apparatuses 300-600 as described with reference to FIGS. 3-6, respectively, can be implemented in various manners, including software, hardware, firmware, or arbitrary combination thereof. For example, in some embodiments, the means in these apparatuses can be implemented using software and/or firmware modules. Alternatively or additionally, various means can also be implemented using hardware modules, for example, implemented as an integrated circuit (IC) chip or application specific integrated circuits (ASIC), and/or a system-on-a-chip (SOC). Other manners that are currently known or developed in the future are also possible, and the scope of the present invention is not limited in this regard.

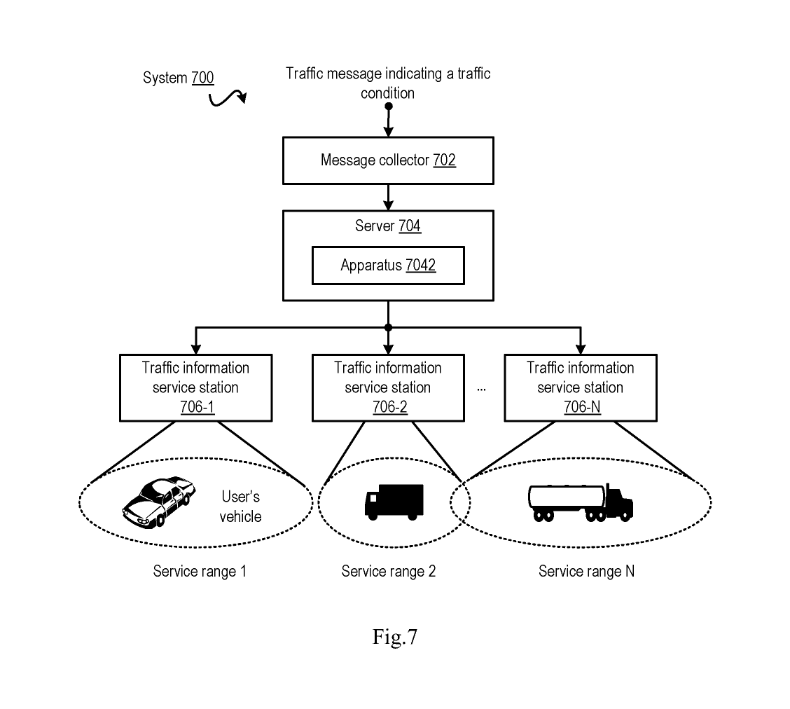

Now, a system 700 for providing a location-based traffic information service according to an embodiment of the present invention will be described with reference to FIG. 7. As illustrated in FIG. 7, the system 700 includes a message collector 702 configurable to collect messages indicating traffic condition. As above mentioned, the messages regarding traffic condition can come from various sources. For example these messages can be generated manually by personnel responsible for traffic condition monitoring, or generated by processing and handling the information obtained by devices such as a camera, a video camera, or a velocimeter. According to embodiments of the present invention, the message collector 702 can be configured to be coupled to a traffic message source in various manners and receive a traffic message indicating the traffic condition from the traffic message source. According to embodiments of the present invention, the message collector 702 can be configured to obtain a text message and/or a speech message.

The system 700 further includes a server 704 that is coupled to the message collector 702 and includes an apparatus 7042 for providing a location-based traffic information service, wherein the apparatus 7042 can be implemented by the apparatus 300 or apparatus 400 as described above with reference to FIG. 3 or 4. In particular, the receiving means in the apparatus 7042 can be configured to receive the traffic message from the message collector 702.

Further, the system 700 also includes at least one traffic information service station 706-1, 706-2, . . . , 706-N (collectively called 706). According to an embodiment of the present invention, the traffic information service station 706 can be implemented by the traffic information service station 500 or 600 as above described with reference to FIG. 5 or 6. Each traffic information service station is configured to receive a matched transport message from the server 704 (more specifically, an apparatus 7042) and broadcast the traffic message within its service range. In particular, as illustrated in FIG. 7, the service ranges 1-N associated with respective traffic information service stations can overlap or not overlap.

According to some embodiments of the present invention, the traffic information service station 706 can include speech message receiving means that is configured to receive a speech message from the server. Alternatively or additionally, the traffic information service station 706 can include text message receiving means configured to receive a text message from the server, and speech converting means configured to convert the received text message into a speech message.

Preferably, the traffic information service station 706 can include radio transmitting means configured to use the radio communication to broadcast the message regarding traffic condition. Moreover, the radio frequencies used by these traffic information service stations can be identical or different.

In the system 700, by classifying by the server 704 (particularly, the apparatus 7042) the traffic messages that are obtained by the message collector 702 and dispatching these traffic messages to different traffic information service stations based on the locations, each traffic information service station can broadcast a traffic message that is specific to the location where it is located within its service range.

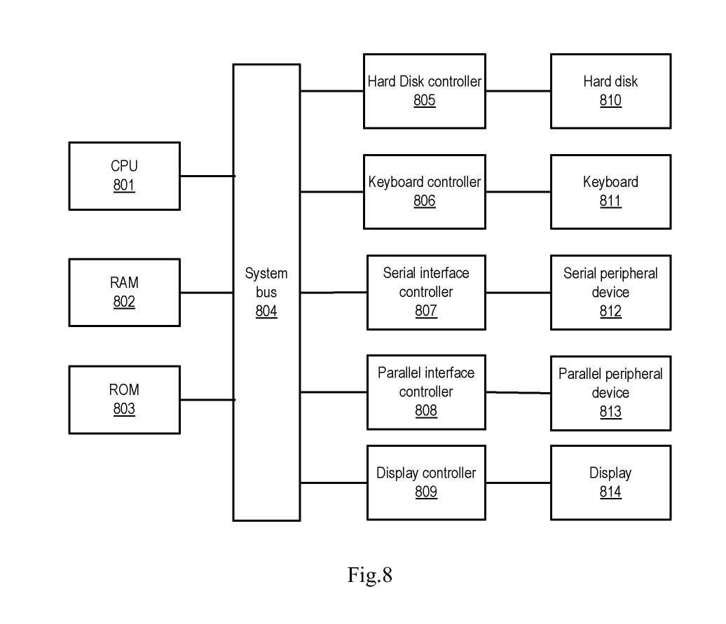

Hereinafter, referring to FIG. 8, a schematic block diagram of a computer system 800 that is adapted to implement embodiments of the present invention is illustrated. For example, the computer system 800 as illustrated in FIG. 8 can be used to implement the above described apparatuses 300-600 and various devices and means as illustrated in FIG. 5. As illustrated in FIG. 8, the computer system includes a CPU (Central Processing Unit) 801, a RAM (Random Access Memory) 802, a ROM (Read Only Memory) 803, a system bus 804, a hard disk controller 805, a keyboard controller 806, a serial interface controller 807, a parallel interface controller 808, a monitor controller 809, a hard disk 810, a keyboard 811, a serial peripheral device 812, a parallel peripheral device 813 and a monitor 814.

Among these components, connected to the system bus 804 are the CPU 801, the RAM 802, the ROM 803, the hard disk controller 805, the keyboard controller 806, the serial interface controller 807, the parallel interface controller 808 and the monitor controller 809. The hard disk 810 is coupled to the hard disk controller 805; the keyboard 811 is coupled to the keyboard controller 806; the serial peripheral device 812 is coupled to the serial interface controller 807; the parallel peripheral device 813 is coupled to the parallel interface controller 808; and the monitor 814 is coupled to the monitor controller 809. It should be understood that the structural block diagram in FIG. 8 is shown only for illustration purpose, and is not intended to limit the scope of the present invention. In some cases, some devices can be added or reduced as required.

It should be understood that besides the hardware embodiments, embodiments of the present invention can be implemented in the manner of a computer program product. For example, the method 100 as described with reference to FIG. 1 and the method 200 that is described with reference to FIG. 2 can be implemented through a computer program product. This computer program product can be stored in RAM 804, ROM 804, hard disk 810 and/or any suitable storage medium as illustrated in FIG. 8, or downloaded to the computer system 800 from a suitable location in the network. The computer program product can include a computer code portion including a program instruction that can be executed through a suitable processing device (for example, CPU 801 in FIG. 8). The program instruction at least can include an instruction for receiving a traffic message indicating a traffic condition, an instruction for determining a traffic information service station matching the message in terms of location, and an instruction that dispatches the message to the matched traffic information service station so as to broadcast the instruction of the message within the service range of the matched traffic information service station.

The idea and principle of the present invention have been illustrated above through a plurality of preferred embodiments of the present invention. It can be appreciated through the above depiction that according to embodiments of the present invention, through replacing the traditional information collection processing pattern with the information classification processing pattern, a distributive and location-based individualized traffic information service can be provided. Further, over the prior solution of location-based service, embodiments of the present invention need no reconstruction of the user's transportation vehicle, thereby reducing overheads and enhancing safety.

It is noted that, each block in the flowcharts or block can represent a module, a program segment, or a part of code, which contains one or more executable instructions for performing specified logic functions. It should be further noted that, in some alternative implementations, the functions noted in the blocks can also occur in a sequence different from what is noted in the drawings. For example, two blocks shown consecutively can be performed in parallel substantially or in an inverse order. It should also be noted that each block in the block diagrams and/or flow charts and a combination of blocks in block diagrams and/or flow charts can be implemented by a dedicated hardware-based system for executing a prescribed function or operation or can be implemented by a combination of dedicated hardware and computer instructions.

The method and apparatus according to embodiments of the present invention can employ a form of complete hardware embodiments, complete software embodiments, or both. In a preferred embodiment, the present invention is implemented as software, including, without limitation to, firmware, resident software, micro-code, etc.

Moreover, the present invention can be implemented as a computer program product usable from computers or accessible by computer-readable media that provide program code for use by or in connection with a computer or any instruction executing system. For the purpose of description, a computer-usable or computer-readable medium can be any tangible means that can contain, store, communicate, propagate, or transport the program for use by or in connection with an instruction execution system, apparatus, or device.

The medium can be an electric, magnetic, optical, electromagnetic, infrared, or semiconductor system (apparatus or device), or propagation medium. Examples of the computer-readable medium can include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-ROM), and DVD.

A data processing system adapted for storing or executing program code can include at least one processor that is coupled to a memory element directly or via a system bus. The memory element can include a local memory usable during actually executing the program code, a mass memory, and a cache that provides temporary storage for at least one portion of program code so as to decrease the number of times for retrieving code from the mass memory during execution.

An input/output or I/O device (including, without limitation to, a keyboard, a display, a pointing device, etc.) can be coupled to the system directly or via an intermediate I/O controller.

A network adapter can also be coupled to the system such that the data processing system can be coupled to other data processing systems, remote printers or storage devices via an intermediate private or public network. A modem, a cable modem, and an Ethernet card are merely examples of a currently usable network adapter.

Though a plurality of embodiments of the present invention have been described above, those skilled in the art should understand that these depictions are only exemplary and illustrative. Based on the teachings and inspirations from the specification, modifications and alterations can be made to the respective embodiments of the present invention without departing from the true spirit of the present invention. Thus, the features in the specification should not be regarded as limitative. The scope of the present invention is only limited by the appended claims.

We claim:

1. An apparatus for providing a location-based traffic information service, comprising:
receiving means configured to receive a traffic message indicating a traffic condition;
determining means configured to determine a traffic information service station matching the traffic information in terms of location; and
dispatching means configured to dispatch the traffic message to the matched traffic information service station, such that the traffic message is broadcasted within a servicing range of the matched traffic information service station.

2. The apparatus according to claim 1, wherein the determining means comprises:
extracting means configured to extract a keyword indicating a location from the traffic message;
calculating means configured to calculating a distance between the location indicated by the keyword and a location of at least one traffic information service station; and
selecting means configured to selecting a traffic information service station that minimizes the distance as the traffic information service station matching the traffic message.

3. The apparatus according to claim 1, wherein the determining means comprises:
extracting means configured to extract a keyword indicating a location from the traffic message;
calculating means configured to calculating a distance between the location indicated by the keyword and a location of at least one traffic information service station; and
selecting means configured to selecting a traffic information service station with the distance smaller than a predetermined threshold as the traffic information service station matching the traffic message.

4. The apparatus according to claim 1, wherein the traffic message is a text message, and the dispatching means comprises:
speech converting means configured to convert the text message into a speech message; and
speech transmitting means configured to transmit the speech message to the matched traffic information service station.

5. The apparatus according to claim 1, wherein the traffic message is a text message, and the dispatching means comprises:
text transmitting means configured to transmit the text message to the matched traffic information service station.

6. A traffic information service station, comprising:
message receiving means configured to receive a traffic message from a server, the server comprising an apparatus for providing a location-based traffic information service according to claim 1; and
message broadcasting means configured to broadcast the traffic message within a service range of the traffic information service station.

7. The traffic information service station according to claim 6, wherein the message receiving means further comprises speech message receiving means configured to receive a speech message from the server.

8. The traffic information service station according to claim 5, wherein the message receiving means further comprises text message receiving means configured to receive a text message from the server, and
wherein the traffic information service station further comprises speech converting means configured to convert the received text message into a speech message.

9. The traffic information service station according to claim 5, wherein the message broadcasting means further comprises radio transmitting means configured to broadcast the traffic message by using a radio communication.

10. The traffic information service station according to claim 9, wherein the radio transmitting means uses a same radio frequency as radio transmitting means of another traffic information service station.
